(19) United States
(12) Patent Application Publication
(10) Pub. No.: US 2018/0330158 A1
(43) Pub. Date: Nov. 15, 2018

(54) BUSINESS CARD OCR WITH CROWD SOURCING

(71) Applicant: Vishal GUPTA, Delhi (IN)

(72) Inventor: Vishal GUPTA, Delhi (IN)

(21) Appl. No.: 15/527,324

(22) PCT Filed: Nov. 29, 2015
(86) PCT No.: PCT/IN2015/050178

§ 371 Date: May 30, 2017

(51) Int. Cl. G06K 9/00; G06Q 10/10; G06F 17/30

(52) U.S. Cl. CPC G06K 9/00483; G06K 9/00469; G06K 2209/01; G06F 17/3028; G06Q 10/109

(57) ABSTRACT

The present invention relates to method and system where the data recognition on a business card subsequently improves through crowd sourcing the information and corrections using a client server architecture. It potentially improves on the state of the art OCR technology currently in use for business card scanning.

### FIELD OF THE INVENTION

The present invention relates to the field of data communication mobile telecommunication. More particularly, relates to a method and apparatus for capturing an image of business card carrying contact information that a user desirous to acquire and automatically correcting business card information in a crowd source business contact database.

### BACKGROUND OF THE INVENTION

A business/visiting card is a small piece of paper or a plastic, which usually carries a contact information. Now days since social networking has played a very important role in everyone's life, it has also become important to move from physical to digital business card, because physical card has several limitations and a small life time. Which carries same even more amount of information as printed on business card. The Business card is shared among people during meetings, seminars quickly to give information about contact for goods and services etc. As such there are approximately 15 billion business cards exchanged hands each year, but about 95% of these cards end up in trash cans. One of the reasons that so many business cards are thrown away is that these business cards are hard to manage and cumbersome to update.

There are applications available for capturing information from a business card and fed in to digital card database. For example BizCardReader from CardReader Inc., SnapScan™ from FutureDial's, WorldCard from AsiaZest (Alestron Inc.) and IRIS Business Card Reader.

The U.S. Pat. No. 8,499,046 describes a method involves receiving an image of a business card in a server from a device associated with a user that receives the business card from a provider of the business card, where image for optical character recognition is processed by using an optical character recognition engine of a server, and thus enables to manage contact information for updating business card by providing latest version of the contact information such as phone and fax number of registered user and by automatically receiving the update about the contact information with or without the knowledge of the user.

There is no known method available for capturing the information from a business card and storing into a crowd source database for automated contact information correction capability. The known available method only describes scanning the contact information a business card and storing into a memory which can be a database or Microsoft outlook address book.

Therefore, there is a need for a method and device performing automatic correction of business card information into a crowd source database. So that the correct new and updated contact information of a business card can be shared electronically among the users.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer system for maintaining a crowd source business card information database with automatically correcting business card information capability is provided.

An object of the present invention is to provide an automated method for business card information correction comprising scanning a business card to perform optical character recognition of a contact information printed therein, identifying one or more headers/identifiers of printed information during the optical character recognition, initiating search of the identified headers/identifiers and associated information for matching in a crowd sourced business card contact information database, if matching found between the one or more of header/identifier information and the stored business card contact information, dynamically updating the one or more headers/identifiers with recognized printed information in the crowd sourced business card contact information database and if no matching found for the header/identifier information in the stored business card contact information, providing one or more option for updating the one or more headers/identifiers information stored in the crowd sourced business card contact information database.

A another object of the present invention is to provide an automated method for business card information correction comprising scanning a business card to perform optical character recognition of contact information printed therein, identifying one or more headers of printed information during said optical character recognition, initiating searching of said identified headers and associated information in a crowd sourced business card contact information database, providing one or more option for updating said one or more headers information stored in said crowd sourced business card contact information database, and dynamically updating one or more said headers information based on said options, with recognized printed information in said crowd sourced business card contact information database.

A furthermore object of the present invention is to provide a business card scanning system comprising a data scanning system including a sensor for scanning a business card for performing optical character recognition of contact information printed therein, a data processing circuits for identifying one or more headers/identifiers of printed information during the optical character recognition; and a crowd sourced database storing business card contact information, wherein the data processing circuit configured to process the scanned information comprising the steps of initiating search of the identified headers/identifiers and associated information for matching in the crowd sourced business card contact information database, if matching found between the one or more of the header/identifier information and the stored business card contact information, dynamically updating the one or more headers/identifiers with recognized printed information in the crowd sourced business card contact information database and if no matching found for header/identifier information in the stored business card contact information, providing one or more option for updating the one or more headers/identifiers, information stored in the crowd sourced business card contact information database.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 shows a simplified block diagram of a contact information discovery system (100) architecture in accordance with an embodiment of the present invention.

FIG. 2 shows an example of a contact information discovery device of FIG. 1 in accordance with an embodiment of the present invention;

FIG. 3 illustrates a flow diagram illustrating process of business card information correction in database accordance with an embodiment of the present invention;

FIG. 4 illustrates another exemplary method of business card information correction/improvement in crowd source database.

### DETAILED DESCRIPTION OF THE PREFERRED EMBODIMENTS

Throughout the following discussion, numerous references will be made regarding servers, services, interfaces, engines, modules, clients, peers, portals, platforms, or other systems formed from mobile devices. It should be appreciated that the use of such terms is deemed to represent one or more mobile devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

One should appreciate that the disclosed contacts directory discovery system provides numerous advantageous technical effects. For example, the contacts directory discovery system of some embodiments enables up-to-date contact information by methodically allowing the persons to update and edit contacts and contact information in shared directories.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the described concepts and does not pose a limitation on the scope of the disclosure. No language in the specification should be construed as indicating any non-claimed essential component.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

This disclosure allow for construction or configuration of a mobile system or device to operate on vast quantities of digital data, beyond the capabilities of a human. The mobile system or device is able to manage the digital data in a manner that could provide utility to a user of the mobile system or device that the user would lack without such a tool.

The present invention will now be described in detail with reference to the accompanying drawings.

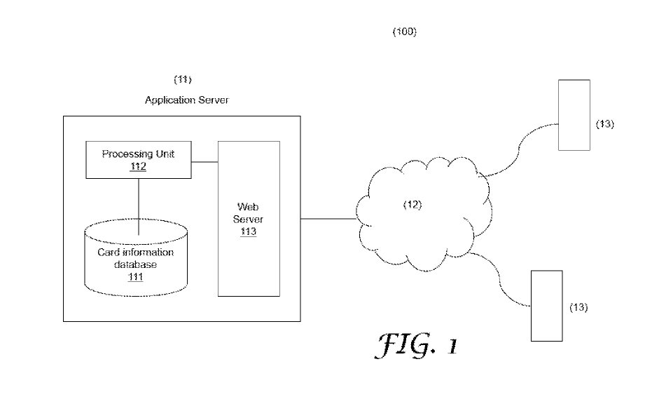

FIG. 1 shows a simplified block diagram of a system (100) architecture in accordance with an embodiment of the present invention. The system 100 includes one or more mobile devices 13, an application server 11 and a network 12 as a medium of communication between them. Although two user mobile devices 110, 120 are illustrated for purposes of the following discussion, the techniques of the present disclosure are not limited to two mobile devices (e.g., mobile devices 13), and apply generally to multiple mobile devices for increased utility, as will become apparent from the following discussions.

Network 130 represents one or more networks used for communication between user mobile devices 13 and Application server 11. Such networks include public and private networks, static and ad hoc networks, wired and wireless networks, wide area networks (WANs), local-area networks (LANs), personal-area networks (PANs), cellular networks, satellite networks, and other networks. Communication between user mobile devices 13 and application server 140 may cross multiple networks. User mobile devices 13 and application server 11 each may include capability to communicate across one or more networks, using the associated standard or proprietary protocol(s) of the network(s). For example, user mobile device 13 may include Wi-Fi communication capability for communication by way of a router to an Internet connection to application server 11, whereas user mobile device 13 may include cellular communication capability for communication by way of a cellular network to an Internet connection to application server 11. Many other networking configurations are also possible, and are within the scope of the present disclosure.

The user device 13 scans or captures a business card image and upload into the mobile device memory for processing. The mobile device application does optical decomposition of scan/captured image to identify the headers/identifiers of information printed in the business card. The information identified during image decomposition includes headers/identifiers such as email, mobile, phone, first name, last name, home phone, office phone, contact, designation, service profile, address, PIN, country, website, skype id, Tel, Fax, etc and associated information with these headers such as email includes abc@dirolabs.com, mobile includes “+1-9123123123”, phone includes “+1-800,800,800”, First name includes “Vishal”, Last name includes “Gupta”, designation includes “CEO”. Website includes www.dirolabs.com etc., The scope of headers/identifiers and corresponding information is not limited to above only. This may include one or more combination and include image, or patterns. The scanned/captured information is processed and identified headers/identifiers with corresponding information is searched into the application server database. For each header/identifier if corresponding information is loosely matched into the database, the processing unit recognizes errors in the match information and stored information and correct to store it. If no information is found into the database processing unit add this information as new business card contact info into the database.

User mobile devices 13, and application server 11 are examples of mobile devices generally, which include hardware, firmware, software, or a combination thereof, and implement a desired functionality by the execution of instructions. Examples of mobile devices include, but are not limited to, a mobile phone, a smart phone, smart watch, a personal digital assistant (PDA), tablet computers, netbook computers, laptop computers, desktop computers, or other similar portable having communication capability.

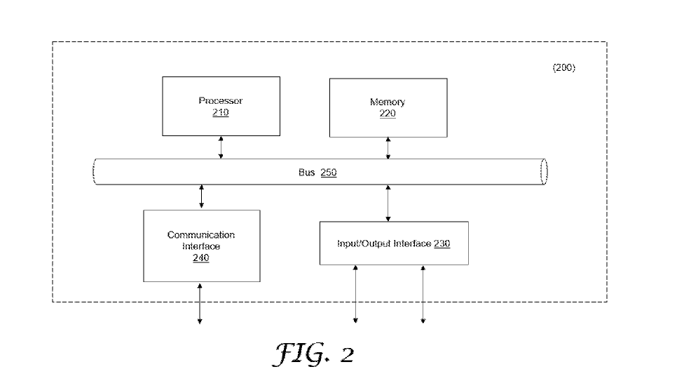

FIG. 2 illustrates an example of a mobile device 200 that includes a processor 210, a memory 220, an input/output interface 230, and a communication interface 240. A bus 250 provides a communication path between two or more of the components of mobile device 200. The components shown are provided by way of illustration and are not limiting. Mobile device 200 may have additional or fewer components, or multiple of the same component.

Processor 210 represents one or more of a general-purpose processor, digital signal processor, microprocessor, microcontroller, application specific integrated circuit (ASIC), field programmable gate array (FPGA), other circuitry effecting processor functionality, or a combination thereof, along with associated logic.

Memory 220 represents one or both of volatile and non-volatile memory for storing information (e.g., instructions and data). Examples of memory include semiconductor memory devices such as RAM, ROM, EPROM, EEPROM and flash memory devices, magnetic disks such as internal hard disks or removable disks, magneto-optical disks, CD-ROM and DVD-ROM disks, and the like. Memory 220 may further represent external memories, such as mass storage devices based on disks or solid state memory devices.

Portions of system 100 may be implemented as computer-readable instructions in memory 220 of mobile device 200, executed by processor 210.

Input/output interface 230 represents electrical components and optional code that together provide an interface from the internal components of mobile device 200 to external components. Examples include a driver integrated circuit with associated programming.

Communications interface 240 represents electrical components and optional code that together provide an interface from the internal components of mobile device 200 to external networks, such as network 130.

Bus 250 represents one or more interfaces between components within mobile device 200. For example, bus 250 may include a dedicated connection between processor 210 and memory 220 as well as a shared connection between processor 210 and multiple other components of mobile device 200.

An embodiment of the disclosure relates to a non-transitory computer-readable storage medium (e.g., memory 220) having computer code thereon for performing various computer-implemented operations related to the techniques of the present disclosure. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (PLDs), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools.

Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions

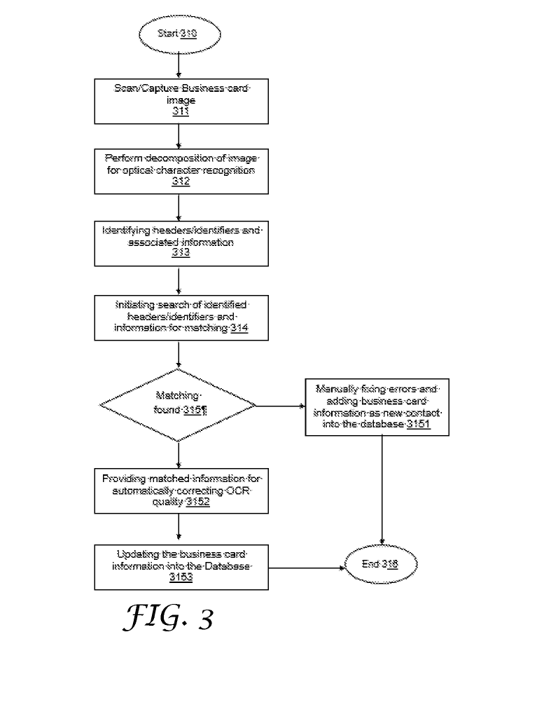

FIG. 3 illustrates a flow diagram illustrating process of business card information correction in database accordance with an embodiment of the present invention. The process start at step 310. The mobile device at step 311 scan/capture business card image using camera. Once the image is captured it is uploaded into the device memory for performing decomposition of image for optical character recognition (at step 312). As the printed information over the business card image is recognized its headers information is identified (at step 313) by the device application such as “e-mail”, “mobile”, “Telephone”, “Fax”, “address” etc. For identified headers and associated information crowd source business card database is searched (at step 314) for similar image. If similar image or recognized information is matched (315) with the information in the crowd source business card information database. The scanned OCR information is automatically corrected (at step 3152) and store (at 3153) into the database. Further, if no match is found in the database user manually fix errors and add (at step 3151) business card information as new contact into the database. The crowd sourced business card databases 13, as describes herein may be local to or remote from the application server 11. In alternative configurations of the application server, different or additional modules may be included in the server 11. For each subsequent scan present invention allows sharing of corrected ocr information for improving subsequent OCRs using a server.

In one of the embodiments the business card giver may also be part of the crowd sourcing process as depicted in FIG. 1. The current OCRs are not 100 percent accurate. This helps increase the accuracy of ocr almost 100 percent for subsequent scans by other users.

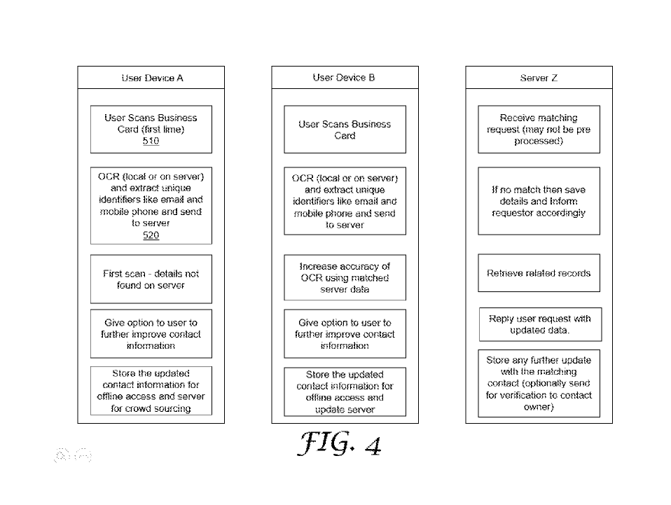

In one of the processes according to an embodiment of present invention as depicted in FIG. 4. The Device A in the example does the scan that is for the first time (10). The device then Ocrs the image using various known techniques and best practices in the field (12). It then sends the data to the server for searching any previous known scans of the data. The server on the first time of receiving the data finds no matching records. The matching procedure may use various algorithms like unique key matching like using email, mobile. It may alternatively use other logics to optimize the matching system including machine learning algorithms like random forest, SVM etc. When the server does not find the matching data. The user ends up manually fixing the errors of OCR in 18,42 of FIG. 1. The data is then stored on the server in processing modules 16 and/or 34. In second scenario Device B scans the same or similar card in FIGS. 1-20, 22 The card is found on the server in module 14. The matching algorithm may require matching image of the business card to be similar or allow for certain changes in the information.

The device B does not have to fix the errors in the OCR because the server is able to provide the corrected information in module 30, 32. Module 60 improves the OCR quality by using the responses from the server.

The client is may still be given an option to update further for next scan in module 62 and 64. All subsequent scans of the business card follow the Device B procedure for perfect OCR accuracy.

Alternatively the business card information is presented to the original owner author of the card for fixing or updating the information when it is scanned for the first time. The listed information on the card is used to further authenticate and authorize the original author to make advanced changes or send out updates to all subsequent card holders. He may further be notified for changes made by any of the card scan users in the crowd sourced database.

Further the OCR period card matching procedure could use image matching to confirm if that card being scanned is the same as the previous crowd sourced data. It may store the previous card images along with the contact data on the server. There are various ways and languages to program this invention easily. It may use single or cluster of servers in client server architecture. It may or may not have a middle tier. The database can be in any SQL or non-sql format on the server side. The OCR engine might be coded on the server side or the client side.

In an embodiment of the present invention of FIG. 1 the internet network or cloud is preferably a public internet. It may also be implemented using the telecom system or any other network.

The Server Z may be a single or multiple clustered servers. They may be virtual, physical, hosted or collocated in a data center or private premises. The server Z may be distributed or centralized. The data on the server Z may be distributed or centralized over multiple devices.

The invention may be coded in any computer language including java, android, iOS etc., by people having sufficient knowledge of client server architecture.

In another embodiment of the invention communication between the servers may be encrypted communication.

All references of reader device may be assumed as mobile device interchangeably and includes scanner and other mobile devices, communication device etc. Further, terms like “device” and “system” are used interchangeably and synonymously throughout this document.

Obviously, numerous modifications and variations of the present disclosure are possible in light of the above teachings. It is therefore to be understood that within the scope of the appended claims, the disclosure may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

1. An automated method for business card information correction comprising:
receiving a scanned business card as an image having optical character recognition (OCR) information;
identifying headers/identifiers from the OCR information;
enabling a search of the headers/identifiers for finding a similar image match in a crowd sourced card content information database, wherein in case a match with a stored business card image is found, OCR information of the scanned business card is corrected based on OCR information of the stored business card image.

2. The method of claim 1, wherein the headers/identifiers are selected from any a combination of email, phone number, mobile number, first name, last name, home phone, office phone, contact, designation, service profile, address, PIN, country, website, Skype ID, Tel, Fax, and the image.

3. The method of claim 1, wherein correction of the OCR information of the scanned business card comprises correction of any or a combination of email, phone number, mobile number, first name, last name, home phone, office phone, contact, designation, service profile, address, PIN, country, website, Skype ID, Tel, Fax, and the image.

4. The method of claim 1, wherein in case a match with a stored business card is not found, OCR information of the scanned business card is added as a new card in the crowd sourced card content information database.

5. The method of claim 1, wherein the matching of the headers/identifiers in the crowd sourced card content information database comprises matching of the image of the scanned business card with a database image stored in the crowd sourced card content information database.

6. The method of claim 1, wherein the OCR information of the scanned business card is corrected after authorization of the owner of the scanned business card.

7. The method of claim 1, wherein no new OCR information is added while correcting the OCR information of the scanned business card.

8. The method of claim 1, wherein the stored business card is stored in the crowd sourced card content information database as an image.

9. (canceled)

10. A business card scanning system comprising:
a scanner for scanning a business card as an image, wherein the image has optical character recognition (OCR) information;
a computing device configured to identify headers/identifiers from the OCR information, said computing device further configured to enable a search of the headers/identifiers for finding a similar image match in a crowd sourced card content information database, wherein in case a match with a stored business card image is found, OCR information of the scanned business card is corrected based on OCR information of the stored business card image.

11. A business card scanning system of claim 10, wherein correction of the OCR information of the scanned business card comprises correction of any or a combination of email, phone number, mobile number, first name, last name, home phone, office phone, contact, designation, service profile, address, PIN, country, website, Skype ID, Tel, Fax, and the image.

12. A business card scanning system of claim 10, wherein the headers/identifiers are selected from any a combination of email, phone number, mobile number, first name, last name, home phone, office phone, contact, designation, service profile, address, PIN, country, website, Skype ID, Tel, Fax, and the image.

13. A business card scanning system of claim 10, wherein in case a match with a stored business card is not found, OCR information of the scanned business card is added as a new card in the crowd sourced card content information database.

14. A business card scanning system of claim 10, wherein matching of the headers/identifiers in the crowd sourced card content information database comprises matching of the image of the scanned business card with a database image stored in the crowd sourced card content information database.
